(19) United States
(12) Patent Application Publication
(10) Pub. No.: US 2019/0329873 A1
(43) Pub. Date: Oct. 31, 2019

(54) WINGLET

(71) Applicant: Airbus Operations Limited, Bristol (GB)

(72) Inventors: Lee PROUDLER, Bristol (GB); Andrew SCAIFE, Bristol (GB); Thomas BARNETT, Bristol (GB)

(21) Appl. No.: 16/391,656

(22) Filed: Apr. 23, 2019

(30) Foreign Application Priority Data
Apr. 27, 2018 (GB) 1806905.4

(51) Int. Cl. B64C 23/06; B64C 3/18

(52) U.S. Cl. CPC B64C 23/069; B64C 3/185

(57) ABSTRACT

A winglet 100 configured for attachment to a wing portion 10 for an aircraft 1000. The winglet 100 includes a first outer wall 101, a second outer wall 102, and one or more spars 114, 116 between the first outer wall 101 and the second outer wall 102. The first outer wall 101 is unitary with the second outer wall 102 and/or with the one or more spars 114, 116.

### TECHNICAL FIELD

The present invention relates to winglets for attachment to wing portions for aircraft, and to methods of manufacturing winglets for attachment to wing portions for aircraft.

### BACKGROUND

Aircraft wings may comprise devices attached thereto to change aerodynamic properties of the wings. One example of such a device is a wing tip fence, which can act to control vortices at a wingtip. Another example device is a winglet, which typically takes the form of small wing-like structure that extends from near the tip of an aircraft wing and is angled with respect to the wing. A winglet may be attached to and extend from an upper, suction side of a wing, or may be attached to and extend from a lower, pressure side of a wing. A winglet can improve the efficiency of an aircraft by improving the lift to drag ratio of a wing. A winglet can also increase an effective wingspan of an aircraft without substantially increasing the actual width of the aircraft. For example, when a wing bends upwards during flight, a winglet attached to and extending from a lower, pressure side of the wing can become level (or more level), so as to provide effective lift and hence act as a quasi-span-extension device. Since the width of an aircraft is often restricted, for example for compatibility with airports, winglets that extend the effective wingspan without extending the width of the plane can be of great utility.

A drawback of some winglets is that assembly can take considerable time and effort.

It would be advantageous for winglets to be more easily and quickly manufactured. It would also be advantageous if winglets met interchangeability requirements, so as to be able to be taken “off the shelf” and be quickly and easily installed onto and/or removed from a wing with minimum reworking of the winglet and/or the wing.

### SUMMARY

A first aspect of the present invention provides a winglet configured for attachment to a pressure side of a wing portion for an aircraft, the winglet comprising: a first outer wall, a second outer wall, and one or more spars between the first outer wall and the second outer wall, wherein the first outer wall is unitary with the second outer wall and/or with the one or more spars.

Optionally, the winglet comprises an erosion shield at a leading edge of the winglet, wherein the erosion shield is non-unitary with the first outer wall and the second outer wall.

A second aspect of the present invention provides a winglet for attachment to a wing portion for an aircraft, the winglet comprising: a first outer wall, a second outer wall, one or more spars between the first outer wall and the second outer wall, and an erosion shield at a leading edge of the winglet, wherein the erosion shield is non-unitary with the first outer wall and the second outer wall, and wherein the first outer wall is unitary with the second outer wall and/or with the one or more spars.

Optionally, in the winglet of the first aspect or the winglet of the second aspect, the erosion shield is a metal erosion shield or a metal alloy erosion shield.

A third aspect of the present invention provides a winglet for attachment to a wing portion for an aircraft, the winglet comprising: a first outer wall, a second outer wall, one or more spars between the first outer wall and the second outer wall, and at least one feature for use in attaching an erosion shield to a leading edge of the winglet, wherein the first outer wall is unitary with the second outer wall and/or with the one or more spars.

Optionally, the, or each, feature is selected from the group consisting of: a captive nut, a threaded hole, contouring for cooperation with the erosion shield, a feature for forming an interference fit with the erosion shield, and a feature for forming a snap fit with the erosion shield.

Optionally, in the winglet of the second aspect or the winglet of the third aspect, the winglet is configured for attachment to a pressure side of the wing portion.

Optionally, in the winglet of any one of the first to third aspects, the first outer wall is unitary with the second outer wall.

Optionally, in the winglet of any one of the first to third aspects, the first outer wall is unitary with the one or more spars.

Optionally, in the winglet of any one of the first to third aspects, the first outer wall is unitary with the second outer wall and unitary with the one or more spars.

Optionally, in the winglet of any one of the first to third aspects, the winglet comprises an end cap at a tip of the winglet, and the end cap is non-unitary with the first outer wall and the second outer wall. Optionally, the end cap is a metal end cap or a metal alloy end cap.

Optionally, in the winglet of any one of the first to third aspects, the winglet comprises one or more features for use in attaching an end cap to a tip of the winglet.

Optionally, in the winglet of any one of the first to third aspects, the winglet comprises a winglet root, the winglet root defines a recess for receiving a connector of the wing portion in use, and a portion of the winglet root that at least partially defines an upper or a lower side of the recess has at least one hole extending therethrough for receiving a fastener for fastening the winglet to the connector when the connector is located in the recess.

Optionally, the winglet root comprises at least one protrusion for receipt into at least one corresponding hole of the wing portion in use.

Optionally, the, or each, protrusion has a root located in the recess.

Optionally, the, or each, protrusion has a tip located in the recess.

Optionally, a tip of the, or each, protrusion is chamfered.

Optionally, the, or each, protrusion is tapered from a root of the protrusion.

Optionally, the, or each, protrusion comprises a fusible portion.

Optionally, the portion of the winglet root comprises the first outer wall or the second outer wall.

A fourth aspect of the present invention provides a winglet configured for attachment to a pressure side of a wing portion for an aircraft, the winglet comprising: a unitary structure, comprising: a first outer wall, a second outer wall, and one or more spars between the first outer wall and the second outer wall.

A fifth aspect of the present invention provides an aircraft comprising at least one winglet according to any one of the first to fourth aspects.

A sixth aspect of the present invention provides a method of manufacturing a winglet for attachment to a wing portion for an aircraft, the method comprising: laying up a first fibre layup for forming a first outer wall, a second fibre layup for forming a second outer wall, and a third fibre layup for forming one or more spars between the first outer wall and the second outer wall; and forming a unitary structure comprising the first outer wall, the second outer wall, and the one or more spars by a process comprising co-curing the first fibre layup with the second fibre layup and the third fibre layup.

Optionally, the process comprises resin transfer moulding.

Optionally, the process comprises same qualified resin transfer moulding.

Optionally, the method comprises attaching an erosion shield to a leading edge of the unitary structure.

Optionally, the method comprises attaching an end cap to a tip of the unitary structure.

Optionally, the winglet is for attachment to a pressure side of a wing portion for an aircraft.

### BRIEF DESCRIPTION OF THE DRAWINGS

Embodiments of the invention will now be described, by way of example only, with reference to the accompanying drawings, in which:

FIG. 1 shows a schematic isometric view of a portion of a wing for an aircraft, and a winglet attached to and extending from a lower, pressure side of the wing portion;

FIG. 2 shows a schematic isometric view of a winglet body of the winglet shown in FIG. 1;

FIG. 3 shows a schematic end view of the winglet body of FIG. 2;

FIG. 4 shows a schematic exploded view of the winglet shown in FIG. 1;

FIG. 5 shows a schematic cross-sectional side view of a root of a winglet and of a connector of a wing portion;

FIG. 6 shows a flow chart illustrating an example of a method of manufacturing a winglet for attachment to a wing portion for an aircraft;

FIG. 7 shows a flow chart illustrating an example of another method of manufacturing a winglet for attachment to a wing portion for an aircraft; and

FIG. 8 shows a schematic front view of an aircraft.

### DETAILED DESCRIPTION

As used herein, the term “upper” is to be interpreted as meaning upper during normal use of the associated component on an aircraft. In some embodiments, an upper side or upper wall of a wing or winglet may be a suction surface of the wing or winglet. As used herein, the term “lower” is to be interpreted as meaning lower during normal use of the associated component on an aircraft. In some embodiments, a lower side or a lower wall of a wing or winglet may be a pressure surface of the wing or winglet.

A drawback of some conventional winglets is that assembly can take considerable time and effort. For example, a conventional winglet may comprise an assembly of first and second outer walls or covers, a set of spars between the covers, a metallic erosion shield and a metallic tip cap, all mechanically fastened together. Some embodiments of the present invention seek to provide winglets that are easier and quicker to assemble.

Moreover, components of winglets that need fixing together using one or more fasteners need to be sufficiently thick and sturdy to cooperate sufficiently with the fastener(s) to enable the components to be held together. The thickness of such components contributes towards the weight of those components, and the winglets as a whole. Some embodiments of the present invention seek to provide winglets that are more lightweight.

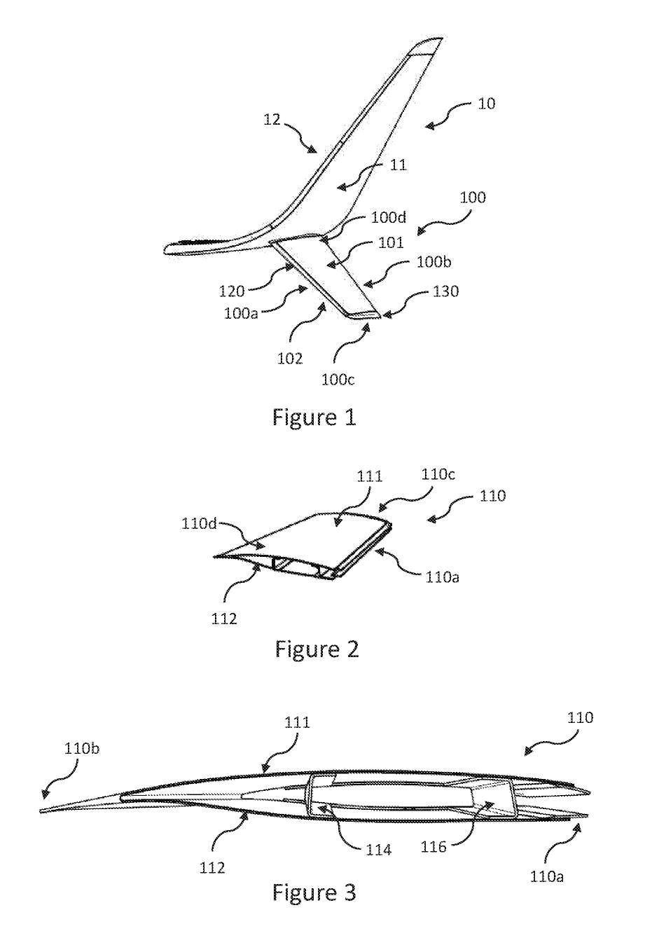

Referring to FIG. 1, there is shown a schematic isometric view of a portion 10 of a wing for an aircraft, and a winglet 100 attached to and extending from a lower, pressure side 11 of the wing portion 10. The wing portion 10 is a wing portion for an aircraft, although the aircraft is not itself shown in full. The winglet 100 is itself configured for attachment to the pressure side 11 of the wing portion 10. It will be appreciated that, in other embodiments, the winglet 100 may be configured for attachment to an upper, suction side 12 of the wing portion 10. Such configuration may comprise changes in the shape or contours of the winglet 100 from those shown, and/or may comprise changes to the features of the winglet 100 that enable its attachment to the wing portion 10.

In this embodiment, the number of wings or blades comprised in the winglet 100 is only one. With reference to FIGS. 1 to 4, broadly speaking the winglet 100 of this embodiment comprises a unitary structure 110, an erosion shield 120 at a leading edge 100a of the winglet 100, and an end cap 130 at a tip 100c of the winglet 100. Each of these components will be discussed in turn.

The unitary structure 110 comprises a first outer wall 111, a second outer wall 112, and two spars 114, 116 between the first outer wall 111 and the second outer wall 112. The first outer wall 111 of the structure 110 is thus unitary with the second outer wall 112 and with the two spars 114, 116. In the assembled winglet 100, the first outer wall 111 of the unitary structure 110 forms a first outer wall 101 of the winglet 100, and the second outer wall 112 of the unitary structure 110 forms a second outer wall 102 of the winglet 100. Therefore, the first and second outer walls 101, 102 of the winglet 100 are unitary with each other and with the spars 114, 116. The unitary structure 110, and thus the first outer wall 111, second outer wall 112, and spars 114, 116, may be made from a non-composite material, or a composite material such as carbon-, glass-, or Kevlar-reinforced plastic.

It will be appreciated that making the first outer wall 111 integral with the second outer wall 112 and/or the spars 114, 116 reduces the part count, and reduces or removes the requirement for mechanical fasteners to hold these components together. As a result, regions of the winglet 100 can have reduced thickness as compared to a conventional winglet. Accordingly, in some embodiments, the winglet 100 can be quicker to assemble with the erosion shield 120 and/or the tip cap 130, and more lightweight than a conventional winglet. It will further be appreciated, at least from FIG. 3, that such unitary or integral structure of the first and second outer walls 101, 102 of the winglet 100 enables a smooth profile of the winglet 100 towards a trailing edge 110b of the unitary structure 110 (which forms a trailing edge 100b of the winglet 100). This can help to avoid considerable disruption to air flow over the winglet 100 in use.

While in this embodiment the first outer wall 111 of the unitary structure 110 forms a substantially upper side of the winglet 100 when in use connected to the wing portion 10, and the second outer wall 112 of the unitary structure 110 forms a substantially lower side of the winglet 100 when in use connected to the wing portion 10, in other embodiments the reverse may be true.

In this embodiment, the spars 114, 116 are sandwiched between the first outer wall 111 and the second outer wall 112 and extend from a root 110d of the unitary structure 110 towards a tip 110c of the unitary structure 110. In this embodiment, the number of spars comprised in the unitary structure 110 is only two. In other embodiments, the number of spars comprised in the unitary structure 110 may be only one, or may be more than two, such as three, four, five, six, or more.

The spar(s) 114, 116 of the winglet 100 carry loads experienced by the winglet 100 when in flight on an aircraft, and the weight of the winglet 100 itself when the aircraft is on the ground. They further help to retain the first and second outer walls 101, 102 relative to each other and to help add rigidity to the winglet 100.

In this embodiment, each of the spars 114, 116 has a substantially C-shaped cross-sectional shape when viewed in a span-wise direction from a root 100d towards a tip 100c of the winglet 100. In other embodiments, the cross-sectional shape of the or each spar may be other than C-shaped, such as circular, elliptical, polygonal or quadrilateral.

Although not shown in the Figures, in some embodiments the winglet 100 may comprise one or more rib(s) that are attached to the spar(s) 114, 116 or unitary with the spar(s) 114, 116, and that are sandwiched between the first outer wall 101 and the second outer wall 102 of the winglet 100. Such rib(s) may extend substantially perpendicularly to the spar(s) 114, 116.

As noted above, the first outer wall 101 of the winglet 100 is unitary with the second outer wall 102 of the winglet 100 and with the two spars 114, 116. However, in other embodiments, the first outer wall 101 of the winglet 100 may be unitary with the one or more spar(s) 114, 116 of the winglet 100 and yet non-unitary with the second outer wall 102 of the winglet 100. In such embodiments, the unitary structure 110 may comprise the first outer wall 111 (which forms the first outer wall 101 of the winglet 100) and the spar(s) 114, 116, and the second outer wall 102 of the winglet 100 may be attached to the unitary structure 110. Such attachment may be by mechanical fasteners or adhesion, for example. In still further embodiments, the second outer wall 102 of the winglet 100 may be unitary with the one or more spar(s) 114, 116 of the winglet 100 and yet non-unitary with the first outer wall 101 of the winglet 100. In such embodiments, the unitary structure 110 may comprise the second outer wall 112 (which forms the second outer wall 102 of the winglet 100) and the spar(s) 114, 116, and the first outer wall 101 of the winglet 100 may be attached to the unitary structure 110. Such attachment may be by mechanical fasteners or adhesion, for example.

In still further embodiments, the first outer wall 101 of the winglet 100 may be unitary with the second outer wall 102 of the winglet 100 and yet non-unitary with the one or more spar(s) 114, 116 of the winglet 100. In such embodiments, the unitary structure 110 may comprise the first outer wall 111 (which forms the first outer wall 101 of the winglet 100) and the second outer wall 112 (which forms the second outer wall 102 of the winglet 100), and the spar(s) 114, 116 may be attached to the unitary structure 110. Such attachment again may be by mechanical fasteners or adhesion, for example.

The erosion shield 120 is provided at the leading edge 100a of the winglet 100 so as to protect the winglet 100, and particularly the unitary structure 110 thereof, from erosion when in flight on an aircraft. The erosion shield 120 may also offer the winglet 100, and particularly the unitary structure 110 thereof, with a degree of protection should something knock the leading edge 100a of the winglet 100 when the aircraft is on the ground. Accordingly, the erosion shield 120 may be made of a suitably hard-wearing material, such as a metal or a metal alloy. An example suitable metal is aluminium, and an example suitable metal alloy is aluminium alloy, titanium alloy, steel, or an alloy of nickel containing chromium and iron (e.g. Inconel). In some embodiments, the erosion shield 120 may be made from an additive layer manufactured (ALM) sintered aluminium or titanium. In some other embodiments, the erosion shield 120 may be made of a less hard-wearing material but be easily replaceable when damaged.

In this embodiment, the erosion shield 120 is non-unitary with the first outer wall 101 and the second outer wall 102, and indeed is non-unitary with the whole of the unitary structure 110. Instead, the erosion shield 120 is attached to one or both of the first and second outer walls 101, 102 of the winglet 100 using a plurality of mechanical fasteners (not shown). More specifically, a leading edge 110a of the unitary structure 110 is contoured to cooperate with an interior of the erosion shield 120. Once the erosion shield 120 is cooperating with the leading edge 110a of the unitary structure 110, one or more fasteners are passed through the erosion shield 120 and into the first and/or second outer walls 111, 112 of the unitary structure 110 to retain the erosion shield 120 in position relative to the unitary structure 110. One or more nuts (not shown) may be captive in the unitary structure 110 and for cooperating with the fastener(s). Preferably, the erosion shield 120 is shaped so that, once attached to the unitary structure 110, an outer surface of the erosion shield 120 is aligned with outer surfaces of the first and second outer walls 101, 102 of the winglet 100. This way, the outer surface of the erosion shield 120 can effectively be considered a continuation of the outer surfaces of the first and second outer walls 101, 102 of the winglet 100, so as not to considerably disrupt air flow over the winglet 100 in use.

In some other embodiments, the erosion shield 120 may be attached to the unitary structure 110 by other than fasteners, such as an interference fit, or a snap fit, for example. Such captive nut(s), contours for cooperation with the erosion shield 120, and features for forming an interference fit or snap fit are examples of features of a winglet 100 for use in attaching the erosion shield 120 at the leading edge 100a of the winglet 100. Other such features, such as one or more threaded holes in the first and/or second outer walls 101, 102 of the winglet 100 for cooperating with male fasteners, will be apparent to the skilled person.

In further embodiments, the erosion shield 120 may be attached to the unitary structure 110 by adhesion or by rivets, for example, and so the winglet 100 may have no distinct features, as such, for use in attaching the erosion shield 120 to the winglet 100.

In still further embodiments, the erosion shield 120 may be co-moulded with the unitary structure 110 during manufacture of the unitary structure 110, and thus not require subsequent attachment to the unitary structure 110.

The end cap 130 is provided at the tip 100c of the winglet 100 so as to protect the tip 100c of the winglet 100, and particularly the unitary structure 110 thereof, from erosion when in flight on an aircraft. The end cap 130 may also offer the winglet 100, and particularly the unitary structure 110 thereof, with a degree of protection should something knock the tip 100c of the winglet 100 when the aircraft is on the ground. Accordingly, the end cap 130 may be made of a suitably hard-wearing material, such as a metal or a metal alloy. An example suitable metal is aluminium, and an example suitable metal alloy is aluminium alloy, titanium alloy, steel, or an alloy of nickel containing chromium and iron (e.g. Inconel). In some embodiments, the end cap 130 may be made from an additive layer manufactured (ALM) sintered aluminium or titanium. In some other embodiments, the end cap 130 may be made of a less hard-wearing material but be easily replaceable when damaged.

In this embodiment, the end cap 130 is non-unitary with the first outer wall 101 and the second outer wall 102, and indeed is non-unitary with the whole of the unitary structure 110. Instead, the end cap 130 is attached to one or both of the first and second outer walls 101, 102 of the winglet 100 using a plurality of mechanical fasteners (not shown). More specifically, a tip 110c of the unitary structure 110 is contoured to cooperate with an interior of the end cap 130. Once the end cap 130is cooperating with the tip 110c of the unitary structure 110, one or more fasteners are passed through the end cap 130 and into the first and/or second outer walls 111, 112 of the unitary structure 110 to retain the end cap 130 in position relative to the unitary structure 110. One or more nuts (not shown) may be captive in the unitary structure 110 and for cooperating with the fastener(s). Preferably, the end cap 130 is shaped so that, once attached to the unitary structure 110, an outer surface of the end cap 130 is aligned with outer surfaces of the first and second outer walls 101, 102 of the winglet 100. This way, the outer surface of the end cap 130 can effectively be considered a continuation of the outer surfaces of the first and second outer walls 101, 102 of the winglet 100, so as not to considerably disrupt air flow over the winglet 100 in use.

In some other embodiments, the end cap 130 may be attached to the unitary structure 110 by other than fasteners, such as an interference fit, or a snap fit, for example. Such captive nut(s), contours for cooperation with the end cap 130, and features for forming an interference fit or snap fit are examples of features of a winglet 100 for use in attaching the end cap 130 at the tip 100c of the winglet 100. Other such features, such as one or more threaded holes in the first and/or second outer walls 101, 102 of the winglet 100 for cooperating with male fasteners, will be apparent to the skilled person.

In further embodiments, the end cap 130 may be attached to the unitary structure 110 by adhesion or by rivets, for example, and so the winglet 100 may have no distinct features, as such, for use in attaching the end cap 130 to the winglet 100.

In still further embodiments, the end cap 130 may be co-moulded with the unitary structure 110 during manufacture of the unitary structure 110, and thus not require subsequent attachment to the unitary structure 110.

In this embodiment, the end cap 130 is non-unitary with the erosion shield 120. This can ease manufacture of these parts, and particularly the erosion shield 120 (which could comprise complex curvature), and may ease attachment (when required) of the end cap 130 and the erosion shield 120 to the unitary structure 110. However, in some embodiments, the end cap 130 may be unitary with the erosion shield 120.

In still further embodiments, the winglet 100 may be free from an end cap 130 and/or free from an erosion shield 120. For example, in some embodiments, the whole winglet 100 may consist solely of the unitary structure 110.

In some embodiments, as shown in FIG. 5, the winglet 100 comprises a winglet root 100d, opposite from the winglet tip 100c, and the winglet root 100d defines a recess 104 for receiving a connector 15 of the wing portion 10 in use.

The connector 15 may be a bracket attached to the rest of the wing portion 10, such as to an aerodynamic surface of the wing portion 10. The connector 15 may be affixed to the aerodynamic surface by way of a plurality of fasteners (not shown) that extend through apertures (not shown) in the connector 15 and are threadably engaged with the threads of respective barrel nuts or anchor nuts (not shown) that are captive within the wing portion 10. The wing portion 10 may include internal bracing to which the connector 15 is securely attached. However, in other embodiments, the connector 15 may be affixed to the aerodynamic surface by some other mechanism, such as non-captive nuts and bolts, an adhesive, may be integral with the aerodynamic surface, or may be surrounded by the aerodynamic surface but not specifically attached to the aerodynamic surface.

The winglet root 100d is the portion of the winglet 100 that is closest to the wing portion 10 when the winglet 100 is attached to the wing portion 10 in use. A portion of the winglet root 100d that at least partially defines an upper or a lower side of the recess 104 may have at least one hole extending therethrough, for receiving a fastener for fastening the winglet 100 to the connector 15 when the connector 15 is located in the recess 104. For example, in the embodiment of FIG. 5, which is a variation to the embodiment of FIGS. 1 to 4, the upper and lower sides of the recess 104 are respectively defined by the first and second outer walls 101, 102 of the winglet 100, and the holes are denoted by reference numerals 101a and 102a. When the connector 15 is located in the recess 104, holes 15a, 15b in the connector 15 are aligned with the holes 101a, 102a in the first and second outer walls 101, 102 of the winglet 100, and the fasteners are passed through the holes 101a, 102a in the first and second outer walls 101, 102 of the winglet 100 and into the holes 15a, 15b in the connector 15. The fasteners may thereafter be retained in position in any suitable manner. For example, the holes 15a, 15b in the connector 15 may be threaded for engagement with the fasteners, or captive nuts may be located in the holes 15a, 15b in the connector 15 and the nuts may be threaded for engagement with the fasteners. Other suitable fastening mechanisms will be apparent to the skilled person. In any event, it will be appreciated that in some embodiments the winglet 100 may be locatable like a glove over the connector 15 of the wing portion 10.

In some embodiments, the winglet root 100d may comprise at least one protrusion for receipt into at least one corresponding hole of the wing portion in use. For example, as again shown in FIG. 5, the winglet root 100d comprises a pair of protrusions 114c, 116c (the second 116c of which is behind the first 114c in FIG. 5, and thus not expressly visible in the drawing) that locate in respective holes 15c, 15d in the connector 15 of the wing portion 10 in use. In other embodiments, the hole(s) of the wing portion 10 into which the protrusion(s) locate may be in a part of the wing portion 10 other than the connector 15, such as in an aerodynamic surface of the wing portion 10.

In this embodiment, one 116c of the protrusions is closer to the leading edge 100a of the winglet 100 than to the trailing edge 100b of the winglet 100, and the other 114c of the protrusions is closer to the trailing edge 100b of the winglet 100 than to the leading edge 100a of the winglet 100. The protrusions 114c, 116c react against the corresponding holes 15c, 15d in use, thereby helping to counter torque loads of the winglet 100 about the connector 15.

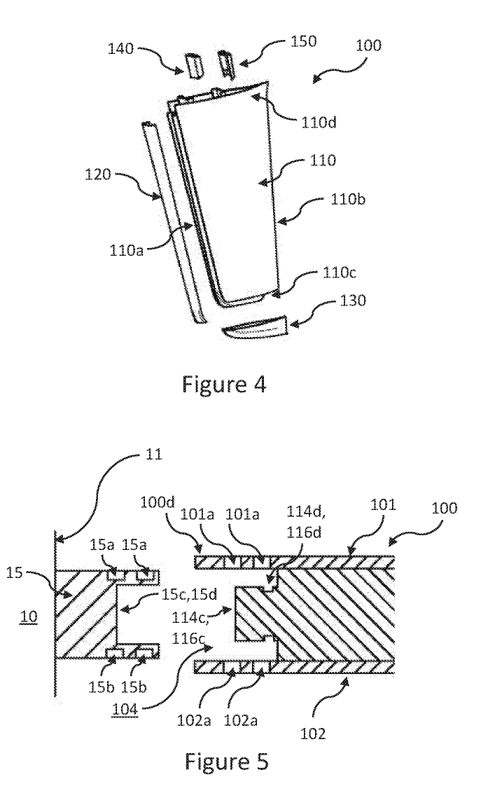

In the embodiment of FIG. 5, the protrusions 114c, 116c are formed by distal ends of the spars 114, 116 of the winglet 100. In other embodiments, such as that of FIGS. 1 to 4, the protrusions are formed by one or more parts 140, 150 (see FIG. 4) of the winglet 100 other than the spar(s). Such one or more parts 140, 150 may be fastened to the winglet 100 during assembly of the winglet 100. Preferably the protrusion(s) are made of a suitably hard-wearing material, such as a metal or a metal alloy. An example suitable metal is aluminium or titanium, and an example suitable metal alloy is aluminium alloy, titanium alloy, steel, or an alloy of nickel containing chromium and iron (e.g. Inconel).

In the embodiment of FIG. 5, each of the protrusions 114c, 116c has a root and a tip (i.e. an end distal from the root) located in the recess 104. As a result, the protrusions 114c, 116c do not extend out of the recess 104 from within the recess 104. However, in other embodiments, the tip(s) and/or root(s) of the protrusion(s) may be located outside of the recess 104. So, in some embodiments, the protrusion(s) 114c, 116c may project from the recess 104 so that the tip(s) of the protrusion(s) is/are outside of the recess 104. Preferably, the or each protrusion extends along an axis that is aligned with the direction in which the connector 15 is to be inserted into the recess 104 in use.

In some embodiments, the or each protrusion of the winglet 100 is a cylindrical protrusion. In other embodiments, the, or each, protrusion may have a different shape, such as a polygonal or elliptical cross-sectional shape.

In some embodiments, a tip of the, or each, protrusion is chamfered. This can aid insertion of the protrusion into the corresponding hole 15c, 15d of the wing portion 10 in use. However, in other embodiments, the tip of the, or each, protrusion may have a different shape, such as rounded-edged, domed or square-edged.

In some embodiments, the, or each, protrusion is tapered from a root of the protrusion. That is, a cross-sectional area of the protrusion perpendicular to the axis of the protrusion reduces with distance from the root. This tapering may aid insertion of the protrusion into the corresponding hole of the wing portion 10 in use, and/or may help in the transfer of shear loads between the protrusion and the connector 15 in use.

In some embodiments, such as that of FIG. 5, each of the protrusions 114c, 116c comprises a fusible portion 114d, 116d. That is, a portion of each protrusion 114c, 116c is purposefully configured to fail or break at a predefined stress, for example sheer stress. This may be useful to ensure that if the winglet 100 were to contact an external object with greater than a predetermined force, the winglet 100 detaches from the wing portion 10 before the force is able to damage the wing portion 10.

Example methods of manufacturing a winglet for attachment to a wing portion for an aircraft will now be described. In some embodiments, the winglet is for attachment to a pressure side of a wing portion for an aircraft.

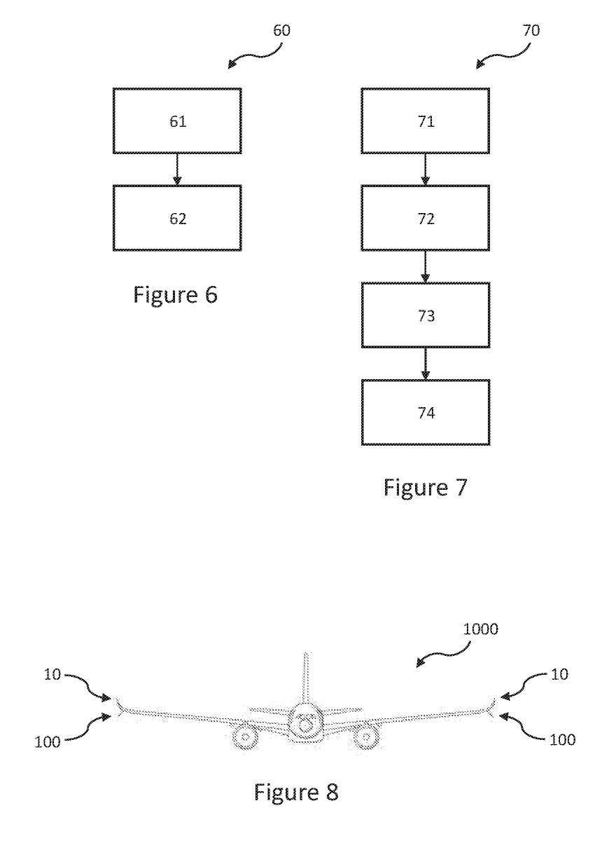

FIG. 6 shows a flow chart illustrating an example of a method of manufacturing a winglet for attachment to a wing portion for an aircraft. The winglet may, for example, be the winglet 100 of FIGS. 1 to 4 or a variant thereof discussed herein.

The method 60 comprises laying up 61 a first fibre layup for forming a first outer wall, a second fibre layup for forming a second outer wall, and a third fibre layup for forming one or more spars between the first outer wall and the second outer wall. The first outer wall may, for example, be the first outer wall 111 or a variant thereof discussed herein. The second outer wall may, for example, be the second outer wall 112 or a variant thereof discussed herein. The one or more spars may, for example, be the spars 114, 116 or a variant thereof discussed herein.

The method 60 also comprises forming 62 a unitary structure comprising the first outer wall, the second outer wall, and the one or spars by a process comprising co-curing the first fibre layup with the second fibre layup and the third fibre layup. The unitary structure may, for example, be the unitary structure 110 or a variant thereof discussed herein.

Further methods of manufacturing a winglet for attachment to a wing portion for an aircraft will now be described with reference to FIG. 7. These methods will be described with reference to the winglet 100 of FIGS. 1 to 4, but it will be appreciated that in other embodiments the winglet 100 may, for example, be one of the variations to the winglet 100 described herein.

The method 70 comprises laying up 71 a first fibre layup for forming a first outer wall, a second fibre layup for forming a second outer wall, and a third fibre layup for forming one or more spars between the first outer wall and the second outer wall. The first outer wall may, for example, be the first outer wall 111 or a variant thereof discussed herein. The second outer wall may, for example, be the second outer wall 112 or a variant thereof discussed herein. The, or each, of the one or more spars may, for example, be the spars 114, 116 or a variant thereof discussed herein.

Each of the first, second and third layups may comprise one or more individual plies. Each of the first, second and third layups may comprise dry fibre non-crimp fabric.

The method 70 also comprises forming 72 a unitary structure comprising the first outer wall, the second outer wall, and the one or spars by a process comprising co-curing the first fibre layup with the second fibre layup and the third fibre layup. The unitary structure may, for example, be the unitary structure 110 or a variant thereof discussed herein.

In some embodiments, the process comprised in the forming 72 stage comprises resin transfer moulding (RTM). Thus, in some embodiments, the forming 72 stage comprises infusing the first to third layups with resin to create a single part that is then cured, with no further assembly work required on that part. In some embodiments, the process comprises same qualified resin transfer moulding (SQRTM). As will be understood by the skilled person, SQRTM is an RTM process in which each of the fibre layups comprises prepreg (i.e. a body of “pre-impregnated” composite fibres in which a thermoset polymer matrix material is present).

The method 70 also comprises attaching 73 an erosion shield to a leading edge of the unitary structure. The erosion shield may, for example, be the erosion shield 120 or a variant thereof discussed herein. The erosion shield may be attached to the unitary structure in any suitable way, such as using one of the methods described herein. In some variations to this method 70, the erosion shield may be placed in the mould together with the first to third fibre layups, and be at least partially captured by a resin used in the process comprised in the forming 72 stage, and thus not require subsequent attachment to the unitary structure. In other embodiments, the erosion shield may be omitted.

The method 70 also comprises attaching 74 an end cap to a tip of the unitary structure. The end cap may, for example, be the end cap 130 or a variant thereof discussed herein. The end cap may be attached to the unitary structure in any suitable way, such as using one of the methods described herein. In some variations to this method 70, the end cap may be placed in the mould together with the first to third fibre layups, and be at least partially captured by a resin used in the process comprised in the forming 72 stage, and thus not require subsequent attachment to the unitary structure. In other embodiments, the end cap may be omitted.

FIG. 8 shows a schematic front view of an example aircraft 1000 comprising winglets 100 attached to respective wing portions 10. Each of the winglets 100 and wing portions 10 is the same as the winglet 100 and wing portion 10, respectively, discussed above with reference to FIGS. 1 to 5. In other embodiments, the winglets 100 and wing portions 10 may be the same as one of the variations to the winglet 100 and wing portion 10, respectively, discussed above with reference to FIGS. 1 to 5.

It is to be noted that the term “or” as used herein is to be interpreted to mean “and/or”, unless expressly stated otherwise.

The above described examples are to be understood as illustrative examples only. Any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims

1. A winglet configured for attachment to a pressure side of a wing portion for an aircraft, the winglet comprising:
a first outer wall,
a second outer wall, and
one or more spars between the first outer wall and the second outer wall,
wherein the first outer wall is unitary with the second outer wall and/or with the one or more spars.

2. The winglet according to claim 1, comprising an erosion shield at a leading edge of the winglet, wherein the erosion shield is non-unitary with the first outer wall and the second outer wall.

3. A winglet for attachment to a wing portion for an aircraft, the winglet comprising:
a first outer wall,
a second outer wall,
one or more spars between the first outer wall and the second outer wall, and
an erosion shield at a leading edge of the winglet,
wherein the erosion shield is non-unitary with the first outer wall and the second outer wall, and
wherein the first outer wall is unitary with the second outer wall and/or with the one or more spars.

4. The winglet according to claim 3, wherein the erosion shield is a metal erosion shield or a metal alloy erosion shield.

5. A winglet for attachment to a wing portion for an aircraft, the winglet comprising:
a first outer wall,
a second outer wall,
one or more spars between the first outer wall and the second outer wall, and
at least one feature configured to attach to an erosion shield to a leading edge of the winglet,
wherein the first outer wall is unitary with the second outer wall and/or with the one or more spars.

6. The winglet according to claim 5, wherein the at least one feature is at least one of: a captive nut, a threaded hole, contouring for cooperation with the erosion shield, a feature for forming an interference fit with the erosion shield, and a feature configured for forming a snap fit with the erosion shield.

7. The winglet according to claim 4, wherein the winglet is configured to attach to a pressure side of the wing portion.

8. The winglet according to claim 1, wherein the first outer wall is unitary with the second outer wall.

9. The winglet according to claim 1, wherein the first outer wall is unitary with the one or more spars.

10. (canceled)

11. The winglet according to claim 1, comprising an end cap at a tip of the winglet, wherein the end cap is non-unitary with the first outer wall and the second outer wall.

12. The winglet according to claim 11, wherein the end cap is a metal end cap or a metal alloy end cap.

13. The winglet according to claim 1, comprising one or more features configured to attach to an end cap to a tip of the winglet.

14. The winglet according to claim 1, comprising a winglet root, wherein the winglet root defines a recess for receiving a connector of the wing portion in use, and wherein a portion of the winglet root that at least partially defines an upper or a lower side of the recess has at least one hole extending therethrough and configured to receive a fastener for fastening the winglet to the connector when the connector is located in the recess.

15. The winglet according to claim 14, wherein the winglet root comprises at least one protrusion for receipt into at least one corresponding hole of the wing portion in use.

16. The winglet according to claim 15, wherein the, or each, protrusion has a root located in the recess.

17. The winglet according to claim 15, wherein the, or each, protrusion has a tip located in the recess.

18. (canceled)

19. A winglet configured for attachment to a pressure side of a wing portion for an aircraft, the winglet comprising:
a unitary structure including:
a first outer wall,
a second outer wall, and
one or more spars between the first outer wall and the second outer wall.

20. (canceled)

21. A method of manufacturing a winglet for attachment to a wing portion for an aircraft, the method comprising:
laying up a first fibre layup for forming a first outer wall, a second fibre layup for forming a second outer wall, and a third fibre layup for forming one or more spars between the first outer wall and the second outer wall; and
forming a unitary structure comprising the first outer wall, the second outer wall, and the one or more spars by a process comprising co-curing the first fibre layup with the second fibre layup and the third fibre layup.

22. (canceled)

23. The method of claim 21, comprising attaching an erosion shield to a leading edge of the unitary structure.

24. The method of claim 21, comprising attaching an end cap to a tip of the unitary structure.

25. (canceled)
